(19) United States
(12) Patent Application Publication
(10) Pub. No.: US 2019/0286140 A1
(43) Pub. Date: Sep. 19, 2019

(54) VEHICLE CONTROL DEVICE

(71) Applicant: HONDA MOTOR CO., LTD., TOKYO (JP)

(72) Inventors: Hiroshi MIURA, WAKO-SHI (JP); Suguru YANAGIHARA, WAKO-SHI (JP); Yuta TAKADA, TOKYO (JP); Shogo KOBAYASHI, WAKO-SHI (JP)

(21) Appl. No.: 16/352,359

(22) Filed: Mar. 13, 2019

(30) Foreign Application Priority Data
Mar. 14, 2018 (JP) 2018-046218

(51) Int. Cl. G05D 1/00; G05D 1/02; B60W 50/14

(52) U.S. Cl. CPC G05D 1/0088; G05D 1/021; B60W 50/14; G05D 1/0257; B60W 2300/17; G05D 2201/0202; G05D 1/0061

(57) ABSTRACT

An external environment recognition unit recognizes a peripheral state of a host vehicle. A control state setting unit sets a control state of automated driving. An action decision unit decides an action of the host vehicle on the basis of the peripheral state that is recognized by the external environment recognition unit and the control state that is set by the control state setting unit. If the external environment recognition unit recognizes a construction section in a road, the control state setting unit sets the control state in accordance with the construction section. A vehicle control unit performs travel control of the host vehicle on the basis of a decision result from the action decision unit.

### CROSS-REFERENCE TO RELATED APPLICATION

This application is based upon and claims the benefit of priority from Japanese Patent Application No. 2018-046218 filed on Mar. 14, 2018, the contents of which are incorporated herein by reference.

### BACKGROUND OF THE INVENTION

### Field of the Invention

The present invention relates to a vehicle control device that performs automated driving or driving assistance of a host vehicle.

### Description of the Related Art

Japanese Laid-Open Patent Publication No. 2009-156783 discloses a navigation device that includes a host vehicle position recognition device. This navigation device corrects host vehicle position information expressing the current position of the host vehicle on the basis of a result of recognizing a ground object or the like. On the other hand, the navigation device does not correct the host vehicle position information when the ground object is moved by construction work, for example. Thus, the navigation device can recognize the host vehicle position with high accuracy.

### SUMMARY OF THE INVENTION

An automated driving vehicle in which a vehicle control device performs at least one type of control among driving, braking, and steering of the host vehicle has been developed in recent years. In addition, the automated driving vehicle that can change a level of automated driving (degree of automation) has been developed. In these automated driving vehicles, the vehicle control device performs vehicle control in accordance with the level of the automated driving that is set at that time. The level of the automated driving vehicle has been set before shipment, or is set by a vehicle occupant appropriately. As the level of the automated driving is higher, the degree of the automated driving is higher and the advanced vehicle control is needed.

For example, in a road where construction is performed as disclosed in Japanese Laid-Open Patent Publication No. 2009-156783, it may be difficult to perform the vehicle control compared with a case in a normal road because of bad condition of a road surface or the like. Thus, the automated driving may be temporarily stopped in a construction section; however, in this case, the vehicle occupant needs to perform the entire vehicle control. Therefore, a psychological burden and a physical burden increase in traveling.

The present invention has been made in view of the above problem and an object is to provide a vehicle control device that can reduce a burden of driving on a vehicle occupant.

A vehicle control device according to the present invention includes: an external environment recognition unit configured to recognize a peripheral state of a host vehicle; a control state setting unit configured to set a control state of automated driving; an action decision unit configured to decide an action of the host vehicle on a basis of the peripheral state that is recognized by the external environment recognition unit and the control state that is set by the control state setting unit; and a vehicle control unit configured to perform travel control of the host vehicle on a basis of a decision result from the action decision unit, wherein if the external environment recognition unit recognizes a construction section in a road, the control state setting unit is configured to set the control state in accordance with the construction section.

In the above configuration, the appropriate automated driving is performed in the construction section. In this manner, even when the host vehicle travels in the construction section, a function of the automated driving can be continued partially or entirely. Thus, a burden of driving on a vehicle occupant can be reduced.

In the present invention, the control state setting unit may be configured to set the control state on a basis of travel environment information in the construction section that is recognized by the external environment recognition unit.

In the above configuration, an automated driving level is set based on the travel environment information. Thus, the automated driving in accordance with a state of the construction section is performed. In this manner, even when the host vehicle travels in the construction section, the function of the automated driving can be continued partially or entirely. Thus, the burden of driving on the vehicle occupant can be reduced.

In the present invention, the travel environment information may include at least one piece of information among entrance information regarding the difficulty of entering the construction section, road surface information regarding a road surface of the construction section, distance information regarding a distance of the construction section, presence or absence of map information of the construction section, and weather information regarding weather in the construction section.

The degree of difficulty in vehicle control changes depending on the difficulty of entering an entrance of the construction section, for example, a width of the entrance. In addition, the degree of difficulty in the vehicle control changes depending on a difference of the road surface of the construction section, for example asphalt, an iron plate, or gravel, or a step at a border between the inside and outside of the construction section. Moreover, the degree of difficulty in the vehicle control changes depending on the distance of the construction section involving many uncertainties. Furthermore, the degree of difficulty in the vehicle control changes depending on the presence or absence of the map of the construction section. In addition, the degree of difficulty in the vehicle control changes depending on the weather in the construction section, for example, the amount of rainfall or the presence or absence of the sunlight.

In the above configuration, the automated driving level is set based on various kinds of information to determine the difficulty in the vehicle control. Thus, the automated driving in accordance with the state of the construction section is performed. In this manner, even when the host vehicle travels in the construction section, the function of the automated driving can be continued partially or entirely. Thus, the burden of driving on the vehicle occupant can be reduced.

In the present invention, the vehicle control device may further include a notification control unit configured to perform notification control to notify a vehicle occupant in accordance with notification content that is decided by the action decision unit, wherein if a distance of the construction section that is recognized by the external environment recognition unit is more than or equal to a predetermined distance, the action decision unit may be configured to decide to perform the notification control to prompt the vehicle occupant to drive manually.

In the above configuration, if the distance of the construction section involving many uncertainties is long, the vehicle control can be taken over to the vehicle occupant after a TOR or the like is performed. On the other hand, if the distance of the construction section is short, at least a part of the vehicle control can be continued in the vehicle side.

In the present invention, the vehicle control device may further include an operation detection unit configured to detect a driving operation of the host vehicle by the vehicle occupant, wherein if the operation detection unit does not detect the driving operation within a predetermined time after the notification to prompt the vehicle occupant to drive manually is performed, the action decision unit may be configured to decide to perform stop control to stop the host vehicle.

If the vehicle occupant does not drive manually after the notification of the TOR or the like is performed, there is a possibility that the vehicle occupant cannot drive manually. In the above configuration, if the driving operation by the vehicle occupant is not detected after the notification of the TOR or the like is performed, the host vehicle is stopped. Thus, the above configuration can cope with a case where the vehicle occupant cannot drive manually.

In the present invention, the vehicle control device may further include a notification control unit configured to perform notification control to notify a vehicle occupant in accordance with notification content that is decided by the action decision unit, wherein if the host vehicle crosses a center line that is a solid line, the action decision unit may be configured to decide to perform the notification control to notify that the host vehicle will cross the center line that is the solid line.

In the above configuration, the vehicle occupant is notified that the host vehicle will cross the center line that is the solid line. Thus, even if the vehicle control that is unusual is performed, for example, the host vehicle crosses the center line that is the solid line, the vehicle occupant can understand that this vehicle is normally controlled.

In the present invention, the vehicle control device may further include a notification control unit configured to perform notification control to notify a vehicle occupant in accordance with notification content that is decided by the action decision unit, wherein if the host vehicle travels in the construction section, the action decision unit may be configured to decide to perform the notification control to notify that the host vehicle will travel in the construction section.

In the above configuration, the vehicle occupant is notified that the host vehicle travels in the construction section. Thus, even if the vehicle control that is unusual is performed, the vehicle occupant can understand that this vehicle control is performed in order to travel in the construction section.

In the present invention, if the external environment recognition unit recognizes a construction vehicle within a predetermined distance from the host vehicle, the action decision unit may be configured to decide to perform offset control that moves a center position of the host vehicle in a vehicle width direction, in a direction that is opposite from a position of the construction vehicle relative to a center position of a travel lane.

There is a case where the construction vehicle in the construction section moves suddenly and a part of the construction vehicle enters a travel path of the host vehicle. In the above configuration, the position of the host vehicle is moved in the direction that is opposite from the position of the construction vehicle. Thus, even if a part of the construction vehicle enters the travel path of the host vehicle, the host vehicle is prevented from being in contact with the construction vehicle.

In the present invention, if the external environment recognition unit recognizes a preceding vehicle that travels ahead of the host vehicle, the action decision unit may be configured to decide to perform trajectory trace control that causes the host vehicle to travel along a travel trajectory of the preceding vehicle.

In the above configuration, the host vehicle travels along the travel trajectory of the preceding vehicle. Thus, the host vehicle can travel in the construction section relatively easily.

By the present invention, the burden of driving on the vehicle occupant can be reduced.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a host vehicle including a vehicle control device according to one embodiment;

FIG. 2 is a function block diagram of a calculation device;

FIG. 3 schematically illustrates a construction section and a peripheral state thereof;

FIG. 4 is a flowchart of a process to be performed by a vehicle control device according to Embodiment 1;

FIG. 5 expresses a score table;

FIG. 6 is a flowchart of a process to be performed by a vehicle control device according to Embodiment 2; and

FIG. 7 is a flowchart of a process to be performed by a vehicle control device according to Embodiment 3.

### DESCRIPTION OF THE PREFERRED EMBODIMENTS

Preferred embodiments of a vehicle control device according to the present invention will be described in detail with reference to the attached drawings.

### [1. Configuration of Host Vehicle 10]

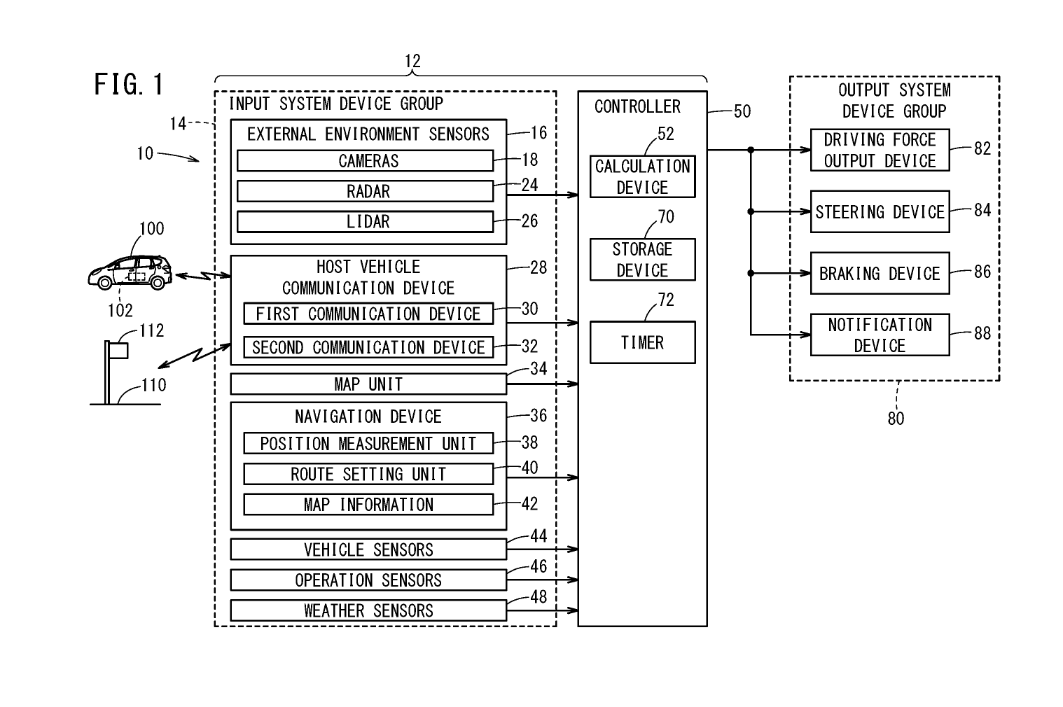

As illustrated in FIG. 1, a host vehicle 10 includes an input system device group 14 that acquires or stores various kinds of information, a controller 50 to which information output from the input system device group 14 is input, and an output system device group 80 that operates in accordance with various instructions output from the controller 50. A vehicle control device 12 according to the present embodiment includes the input system device group 14 and the controller 50. The host vehicle 10 is an automated driving vehicle in which travel control is performed by the controller 50 (including fully automated driving vehicle) or a driving assistance vehicle in which travel control is assisted partially.

### [1.1. Input System Device Group 14]

The input system device group 14 includes external environment sensors 16, a host vehicle communication device 28, a map unit 34, a navigation device 36, vehicle sensors 44, operation sensors 46, and weather sensors 48. The external environment sensors 16 detect a state of a periphery (external environment) of the host vehicle 10. The external environment sensors 16 include a plurality of cameras 18 that photographs the external environment, a plurality of radars 24 and one or more LIDARs 26 that detect the distance and the relative speed between the host vehicle 10 and peripheral objects. The host vehicle communication device 28 includes a first communication device 30 and a second communication device 32. The first communication device 30 performs inter-vehicle communication with an other-vehicle communication device 102 provided for another vehicle 100 to acquire external environment information including information regarding the other vehicle 100 (such as a type of vehicle, a travel state, or a travel position). The second communication device 32 performs road-vehicle communication with a road-side communication device 112 provided for an infrastructure such as a road 110 to acquire external environment information including the road information (such as information regarding a traffic light or a traffic jam). The map unit 34 stores high-precision map information including the number of lanes, the type of lane, the lane width, and the like. The navigation device 36 includes a position measurement unit 38 that measures the position of the host vehicle 10 by a satellite navigation method and/or a self-contained navigation method, map information 42, and a route setting unit 40 that sets a scheduled route from the position of the host vehicle 10 to a destination on the basis of the map information 42. The vehicle sensors 44 detect the travel state of the host vehicle 10. The vehicle sensors 44 include a vehicle speed sensor, an acceleration sensor, a yaw rate sensor, an inclination sensor, a travel distance sensor, and the like, that are not shown. The operation sensors 46 detect whether or not, or how much an accelerator pedal, a braking pedal, and a steering wheel are operated. The operation sensors 46 include an accelerator position sensor, a brake switch, a rotation sensor, a torque sensor, a grip sensor, and the like that are not shown. The weather sensors 48 detect a weather state at the travel position of the host vehicle 10. The weather sensors 48 include a raindrop sensor, a solar radiation sensor, and the like.

### [1.2. Output System Device Group 80]

The output system device group 80 includes a driving force output device 82, a steering device 84, a braking device 86, and a notification device 88. The driving force output device 82 includes a driving force output ECU, and a driving source such as an engine or a traction motor. The driving force output device 82 generates driving force in accordance with a vehicle occupant's operation of the accelerator pedal or a driving control instruction that is output from the controller 50. The steering device 84 includes an electric power steering system (EPS) ECU and an EPS actuator. The steering device 84 generates a steering force in accordance with a vehicle occupant's operation of the steering wheel or a steering control instruction that is output from the controller 50. The braking device 86 includes a braking ECU and a braking actuator. The braking device 86 generates a braking force in accordance with a vehicle occupant's operation of the braking pedal or a braking control instruction that is output from the controller 50. The notification device 88 includes a notification ECU and an information transmission device (such as a display device, an audio device, or a haptic device). The notification device 88 notifies a vehicle occupant in accordance with a notification instruction that is output from the controller 50 or another ECU.

### [1.3. Controller 50]

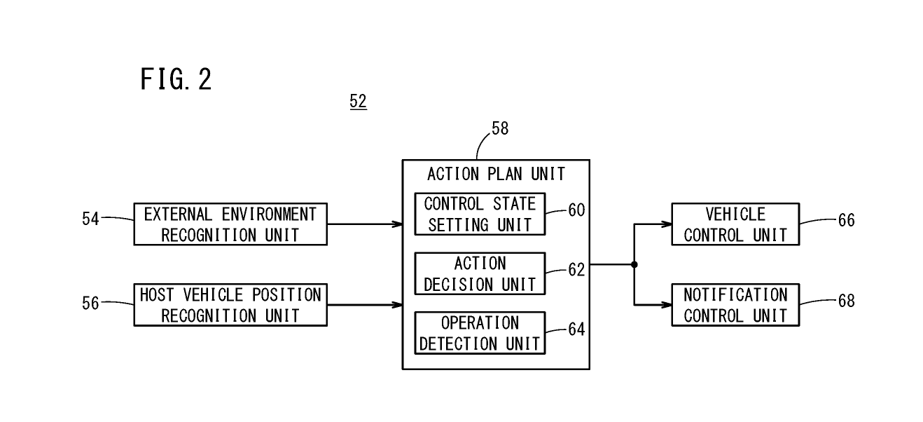

The controller 50 is configured by an ECU, and includes a calculation device 52 such as a processor and a storage device 70 such as a ROM or a RAM. The controller 50 achieves various functions when the calculation device 52 executes programs stored in the storage device 70. As illustrated in FIG. 2, the calculation device 52 functions as an external environment recognition unit 54, a host vehicle position recognition unit 56, an action plan unit 58, a vehicle control unit 66, and a notification control unit 68.

The external environment recognition unit 54 recognizes the peripheral state of the host vehicle 10 on the basis of the information output from the external environment sensors 16, the host vehicle communication device 28, the map unit 34, and the navigation device 36. For example, the external environment recognition unit 54 recognizes the existence, position, size, type, and entry direction of the other vehicle 100 that travels or stops near the host vehicle 10 and moreover recognizes the distance and the relative speed between the host vehicle 10 and the other vehicle 100, on the basis of image information acquired by the cameras 18, information acquired by the radars 24 and the LIDARs 26, and the external environment information acquired by the first communication device 30. In addition, the external environment recognition unit 54 recognizes the shape, type and position of a recognition object included in the road environment on the basis of the image information acquired by the cameras 18, the information acquired by the radars 24 and the LIDARs 26, the map information 42, and the external environment information acquired by the second communication device 32. The external environment recognition unit 54 recognizes a signal expressed by a traffic light or a temporary traffic light 154 (an entry possible state, or an entry impossible state) on the basis of the image information acquired by the cameras 18 and the external environment information acquired by the second communication device 32.

The host vehicle position recognition unit 56 recognizes the position of the host vehicle 10 on the basis of the information output from the map unit 34 and the navigation device 36.

An action to be performed by the host vehicle 10 is determined based on recognition results from the external environment recognition unit 54 and the host vehicle position recognition unit 56, and the detected information and stored information of the input system device group 14. If the travel control is performed, a travel trajectory and a target speed are generated. In the present embodiment, the action plan unit 58 includes a control state setting unit 60, an action decision unit 62, and an operation detection unit 64. The control state setting unit 60 sets a control state of automated driving, specifically, an automated driving level. Setting the automated driving level includes changing the automated driving level from the level X to the level Y. The action decision unit 62 decides an action of the host vehicle 10 on the basis of the peripheral state recognized by the external environment recognition unit 54 and the automated driving level set by the control state setting unit 60. The operation detection unit 64 detects a driving operation of the host vehicle 10 performed by the vehicle occupant on the basis of the detected information of the operation sensors 46.

The vehicle control unit 66 controls the output system device group 80 on the basis of behavior of the host vehicle 10 planned by the action plan unit 58. For example, the vehicle control unit 66 calculates a steering instruction value based on the travel trajectory generated by the action plan unit 58, and an acceleration/deceleration instruction value based on the target speed, and outputs control instructions to the driving force output device 82, the steering device 84, and the braking device 86.

The notification control unit 68 outputs the notification instruction to the notification device 88 on the basis of a notification action planned by the action plan unit 58.

The storage device 70 illustrated in FIG. 1 stores numerals such as thresholds used in comparison, determination, or the like in each process, in addition to various programs to be executed by the calculation device 52.

### [2. Circumstance Assumed in the Present Embodiment]

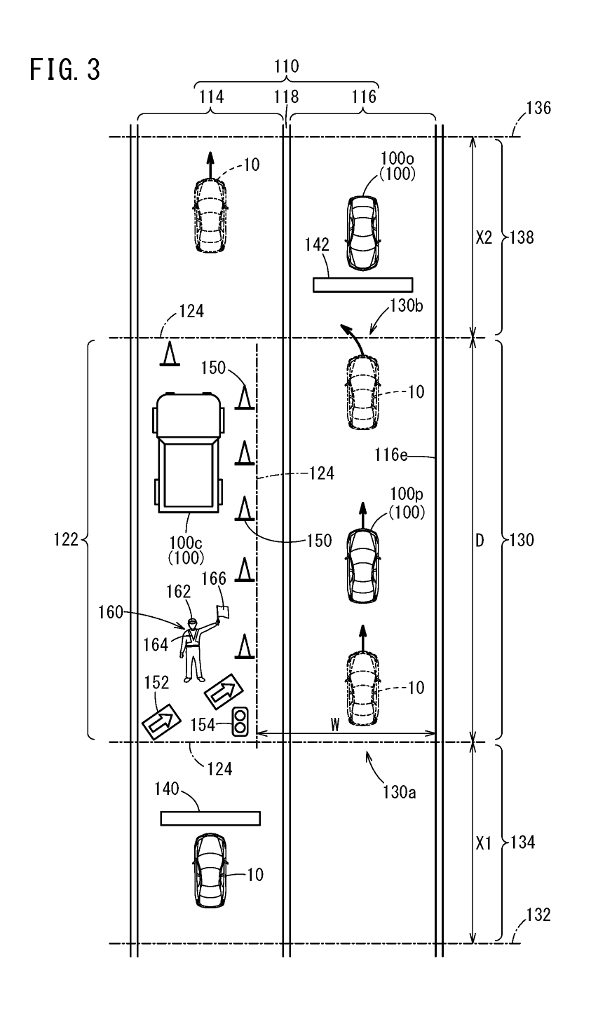

The present embodiment mainly describes a circumstance illustrated in FIG. 3. As illustrated in FIG. 3, the road 110 includes a first travel path 114 and a second travel path 116 in which vehicles travel in opposite (counter) directions. The first travel path 114 and the second travel path 116 are sectioned by a center line 118. The host vehicle 10 travels in the first travel path 114, and an oncoming vehicle 100o as the other vehicle 100 travels in the second travel path 116. In a part of the road 110, there is a construction section 130 including a construction site 122. The construction site 122 blocks the first travel path 114. Thus, vehicles can travel in the construction section 130 by using the second travel path 116 (one-side alternate traffic).

Definitions in the present specification are described below. The construction site 122 is an area including an installation object peculiar to the construction (cones 150, a sign 152, the temporary traffic light 154, or the like), a construction vehicle 100c, a traffic control person 160, or the like. Borders 124 of the construction site 122 are estimated by connecting the installation object that is positioned at the outermost periphery of the construction site 122, the construction vehicle 100c, the traffic control person 160, and the like. A traveling direction in the first travel path 114 (upward direction in FIG. 3) is a forward direction, and a traveling direction in the second travel path 116 (downward direction in FIG. 3) is a backward direction. In the present specification, a section where the construction site 122 exists in the road 110 is referred to as the construction section 130. A part where vehicles enter a travel possible area of the construction section 130 in the forward direction is referred to as an entrance 130a of the construction section 130, and a part where vehicles exit from the travel possible area of the construction section 130 in the forward direction is referred to as an exit 130b of the construction section 130.

In the first travel path 114 on the backward direction side of the construction site 122, a first stop line 140 is set. In the second travel path 116 on the forward direction side of the construction site 122, a second stop line 142 is set. The road 110 from the construction site 122 to a first position 132 that is separated from the construction site 122 by a predetermined distance X1 toward the backward direction is referred to as an entrance area 134. The entrance area 134 includes the entrance 130a of the construction section 130 and the first stop line 140. Similarly, the road 110 from the construction site 122 to a second position 136 that is separated from the construction site 122 by a predetermined distance X2 toward the forward direction is referred to as an exit area 138. The exit area 138 includes the exit 130b of the construction section 130 and the second stop line 142.

### [3. Definition of Automated Driving Level]

The automated driving level is operation control information that is classified into a plurality of stages on the basis of the degree of control by the vehicle control device 12 with respect to the operation of acceleration, steering, and braking of the host vehicle 10, and the degree of participation of the vehicle occupant who operates the host vehicle 10 in a vehicle operation. Examples of the automated driving level include the following. Note that this classification is one example, and the concept of the present invention is not limited to this example.

(1) Level 1 (Single Type Automated Driving)

At the level 1, the vehicle control device 12 performs operation control of any one of the acceleration, the steering, and the braking of the host vehicle 10. All operations except for the operation to be controlled by the vehicle control device 12 need the participation of the vehicle occupant. At the level 1, the vehicle occupant needs to keep a posture with which the vehicle occupant can drive safely at any time (obliged to monitor the periphery).

(2) Level 2 (Combined Automated Driving)

At the level 2, the vehicle control device 12 performs the operation control of more than one of the acceleration, the steering, and the braking of the host vehicle 10. The degree of participation of the vehicle occupant is lower than that at the level 1. Even at the level 2, the vehicle occupant needs to keep the posture with which the vehicle occupant can drive safely at any time (obliged to monitor the periphery).

(3) Level 3 (Advanced Automated Driving)

At the level 3, the vehicle control device 12 performs all of the operations with respect to the acceleration, the steering, and the braking. Only when the vehicle control device 12 requests the vehicle occupant to drive, the vehicle occupant operates the host vehicle 10. At the level 3, the vehicle occupant does not need to monitor the periphery during the travel in the automated driving. At the level 3, the degree of participation of the vehicle occupant is lower than that at the level 2.

(4) Level 4 (Fully Automated Driving) At the level 4, the vehicle control device 12 performs all of the operations with respect to the acceleration, the steering, and the braking. The vehicle occupant does not participation in the operation of the host vehicle 10 at all. At the level 4, automated traveling is performed in all the distance where the host vehicle 10 travels. The vehicle occupant does not need to monitor the periphery during the travel in the automated driving. At the level 4, the degree of participation of the vehicle occupant is lower than that at the level 3.

In the description below, the automated driving level where the vehicle occupant needs to monitor the periphery is referred to as a low automated driving level, and the automated driving level where the vehicle occupant does not need to monitor the periphery is referred to as a high automated driving level.

### [4. Operation of Vehicle Control Device 12]

### [4.1 Embodiment 1]

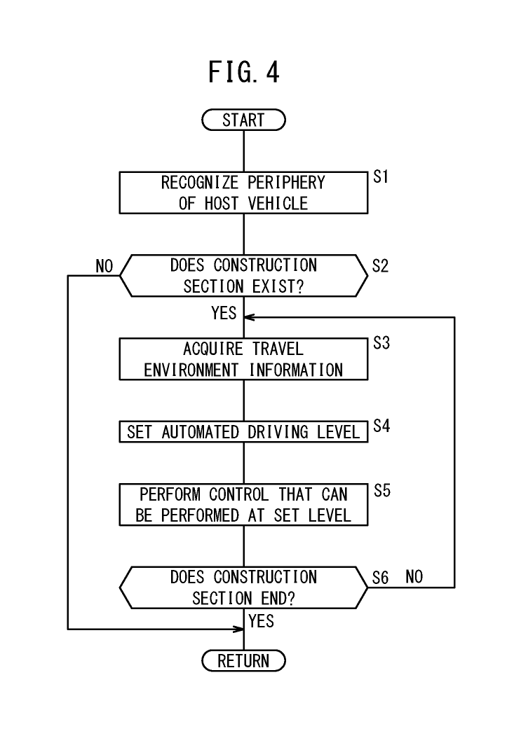

An operation of the vehicle control device 12 according to Embodiment 1 is described with reference to FIG. 4. A process shown in FIG. 4 is performed at predetermined time intervals while the vehicle control device 12 performs the automated driving.

In step S1, the external environment recognition unit 54 recognizes the peripheral state of the host vehicle 10 on the basis of the latest information that is output from the input system device group 14. Note that the external environment recognition unit 54 recognizes the peripheral state of the host vehicle 10 periodically in parallel with each process below.

In step S2, the external environment recognition unit 54 recognizes whether the construction section 130 exists. For example, it is recognized whether the construction section 130 exists by identifying the installation object peculiar to the construction site 122 (the cones 150, the sign 152, the temporary traffic light 154, or the like), the construction vehicle 100c, the traffic control person 160, or the like on the basis of the image information acquired by the cameras 18. The external environment recognition unit 54 identifies as the traffic control person 160, a person who wears a helmet 162 or a working uniform 164 that emits light, or a person who has a handflag 166 or a traffic wand (not shown).

If the external environment recognition unit 54 recognizes the construction section 130 (step S2: YES), the process advances to step S3. On the other hand, if the external environment recognition unit 54 does not recognize the construction section 130 (step S2: NO), a series of processes is terminated. At this time, the control state setting unit 60 maintains the automated driving level. The action plan unit 58 generates the target speed and the travel trajectory that cause the host vehicle 10 to travel in the first travel path 114, so that the host vehicle 10 travels in the first travel path 114.

Note that if the traffic control person 160 wears neither the helmet 162 nor the working uniform 164 or if the traffic control person 160 has neither the handflag 166 nor the traffic wand, the external environment recognition unit 54 recognizes that the reliability of the traffic control person 160 is low. For example, if the temporary traffic light 154 is exposed to the sunlight and it is difficult to recognize the display of the temporary traffic light 154, the external environment recognition unit 54 recognizes that the reliability of the temporary traffic light 154 is low. If the external environment recognition unit 54 recognizes the construction section 130 on the basis of the traffic control person 160, the temporary traffic light 154, or the like, but the reliability is low in step S2, the process advances to step S3.

When the process has advanced from step S2 to step S3, the control state setting unit 60 acquires travel environment information in the construction section 130 that is recognized by the external environment recognition unit 54. The travel environment information includes various kinds of information regarding the construction section 130, such as entrance information regarding the degree of difficulty of entering the construction section 130, road surface information regarding a road surface of the construction section 130, distance information regarding a distance D of the construction section 130, the presence or absence of the map information 42 of the construction section 130, and weather information regarding the weather in the construction section 130. The entrance information includes information of a width W of the entrance 130a of the construction section 130. The width W is determined based on the image information acquired by the cameras 18.

The road surface information includes information of the kind of the road surface (asphalt, an iron plate, or the like). The kind of the road surface is determined based on the image information, or the detection result from the radars 24 or the LIDARs 26. The distance information includes information of the distance D of the construction section 130. The distance D is determined based on the image information acquired by the cameras 18 and the external environment information acquired by the second communication device 32. The weather information includes information of the type of the weather (sunny, cloudy, rainy, snowy, or the like). The type of the weather is determined based on the external environment information, a weather forecast in a wide area, the detection result from the weather sensors 48, or the like. Also, an illuminance sensor or the like may detect information of the brightness of sunlight that enters the cameras 18.

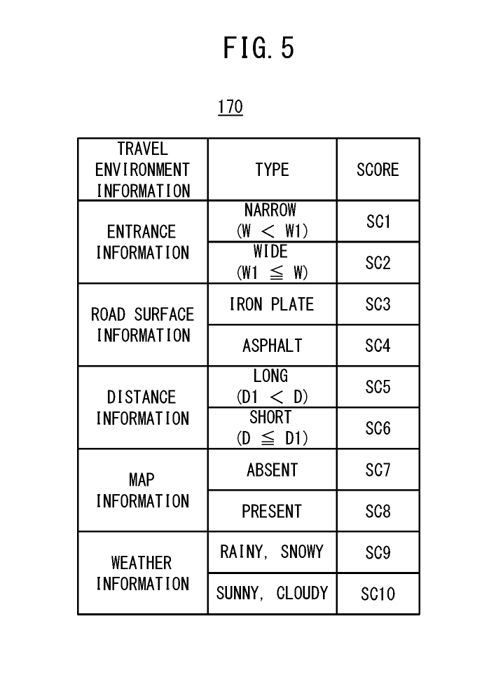

In step S4, the control state setting unit 60 sets the automated driving level on the basis of the acquired travel environment information. For example, the control state setting unit 60 scores each travel environment information. The storage device 70 stores a score table 170 as shown in FIG. 5. The score table 170 sets each score SC1 to SC10 for each kind of the travel environment information. The control state setting unit 60 determines the score for each travel environment information acquired in step S3 by referring to the score table 170, and calculates the total score. Then, the control state setting unit 60 sets the automated driving level in accordance with the total score. For example, if the width W of the entrance 130a is narrow, the steering is difficult, so that the degree of difficulty in the automated driving is high. In addition, if the road surface is the iron plate, the road surface is slippery, so that the degree of difficulty in the automated driving is high. Moreover, if the distance D of the construction section 130 is long or there is no information of the construction section 130 in the map information 42, then there are many uncertainties in the travel path, so that the degree of difficulty in the automated driving is high. Furthermore, for example, if it is rainy or snowy, the road surface is slippery, and if the sunlight enters the cameras 18 directly, the information amount of the image information decreases. Thus, in such cases, the degree of difficulty in the automated driving is high. The score table 170 is set so that the score is low in these cases and the score is high in the opposite cases. That is to say, as the total score is lower, the degree of difficulty in the automated driving is higher. Thus, as the total score is lower, the control state setting unit 60 sets the automated driving level to be lower and decreases the degree of the automation of the travel control. In this case, the degree of the automation of the control regarding the travel environment information whose score is low may be decreased. Note that the score table 170 shown in FIG. 5 and the travel environment information, the type, and the score that are included in the score table 170 are just examples, and are not limited to these examples.

The automated driving level that can be performed may be evaluated by changing weighting in accordance with each travel environment information instead of by the score table 170.

In step S4, the control state setting unit 60 does not change the automated driving level to a higher level. That is to say, if the score is high and the automated driving level can be changed to a level higher than the level set at that time, the control state setting unit 60 maintains the automated driving level.

In step S5, the action decision unit 62 determines the driving, the steering, and the braking that can be performed in the automated driving level that is set. The vehicle control unit 66 outputs to the output system device group 80, the instruction value in accordance with the control of the driving, the steering, and the braking that is determined by the action decision unit 62. The driving force output device 82, the steering device 84, and the braking device 86 operate in accordance with the instructions output from the vehicle control unit 66.

In step S6, the external environment recognition unit 54 recognizes the presence or absence of the exit area 138 continuously or at constant time intervals while the host vehicle 10 travels in the construction section 130. For example, if the external environment recognition unit 54 stops recognizing the installation object peculiar to the construction site 122, such as the cones 150, in other words, it is recognized that the number of lanes increases to the first travel path 114 side, the external environment recognition unit 54 recognizes the exit area 138. Alternatively, the external environment recognition unit 54 recognizes the exit area 138 by recognizing that the travel path width where the host vehicle 10 can travel increases to the first travel path 114 side by a predetermined amount or more, or a predetermined rate or more. Further alternatively, the external environment recognition unit 54 can recognize the exit area 138 by recognizing that a preceding vehicle 100p moves to the first travel path 114 side, or recognizing a road sign expressing that the construction section 130 ends. The external environment recognition unit 54 recognizes the end of the construction section 130 by recognizing the exit area 138.

If the external environment recognition unit 54 recognizes the end of the construction section 130 (step S6: YES), a series of the processes ends. On the other hand, if the external environment recognition unit 54 does not recognize the end of the construction section 130 (step S6: NO), the process returns to step S3.

### [4.2 Embodiment 2]

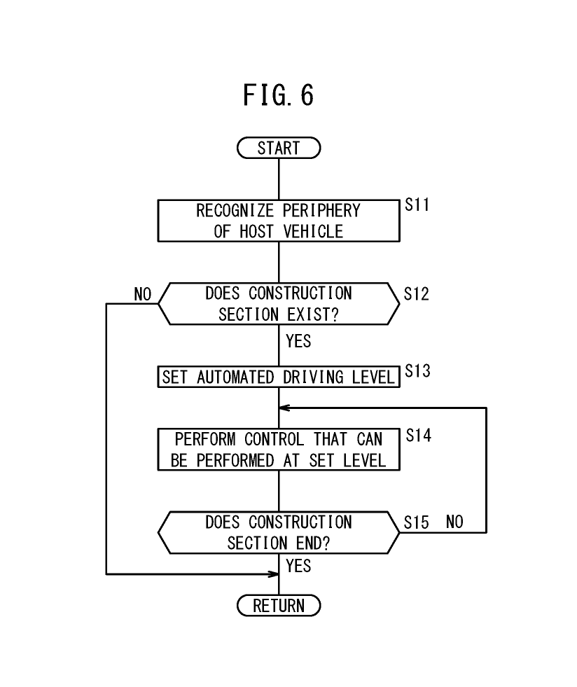

An operation of the vehicle control device 12 according to Embodiment 2 is described with reference to FIG. 6. In Embodiment 1, the automated driving level is set based on the travel environment information recognized by the external environment recognition unit 54. On the other hand, in Embodiment 2, a predetermined automated driving level is set when the external environment recognition unit 54 recognizes the construction section 130. A process shown in FIG. 6 is performed at predetermined time intervals while the vehicle control device 12 performs the automated driving.

Processes of step S11, step S12, step S14, and step S15 in FIG. 6 correspond to the processes of step S1, step S2, step S5, and step S6 in FIG. 4. Thus, description of these processes is omitted.

When the process has advanced from step S12 to step S13, the control state setting unit 60 sets the automated driving level. Here, the automated driving level is set to a predetermined automated driving mode (construction section mode) that is stored in the storage device 70 in advance. However, similarly to step S4 in FIG. 4, the control state setting unit 60 does not change the automated driving level to a higher level.

### [4.3 Embodiment 3]

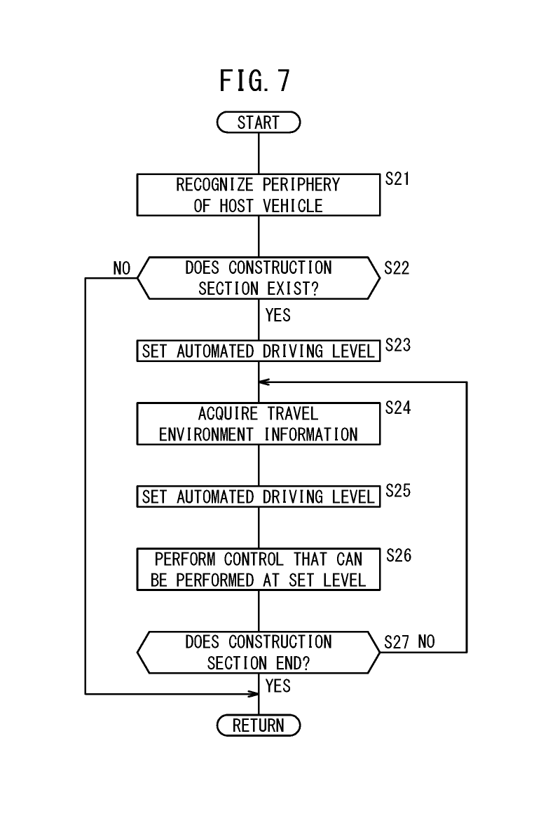

As shown in FIG. 7, Embodiment 1 and Embodiment 2 may be combined. Processes of step S21, step S22, and step S24 to step S27 among processes in FIG. 7 correspond to the processes of step S1 to step S6 in FIG. 4. In addition, a process of step S23 among the processes in FIG. 7 corresponds to the process of step S13 in FIG. 6.

### [5. Examples of Additional Control]

In step S5 in FIG. 4, various kinds of control that can be performed in the automated driving level that is set at that time may be further performed. Examples of the various kinds of control are described below.

### [5.1. Example 1]

The action decision unit 62 decides to perform notification control to notify the vehicle occupant that the host vehicle 10 will travel in the construction section 130.

The notification control unit 68 outputs to the notification device 88, the notification instruction in accordance with notification content that is decided by the action decision unit 62. Then, the notification device 88 notifies the vehicle occupant that the host vehicle 10 will travel in the construction section 130.

### [5.2. Example 2]

If the degree of the automation is decreased in step S4, the vehicle occupant needs to perform the travel control of the host vehicle 10 partially or entirely. In this case, the action decision unit 62 decides to perform the notification control to prompt the vehicle occupant to drive manually. The notification control unit 68 outputs to the notification device 88, the notification instruction in accordance with the notification content that is decided by the action decision unit 62. Then, the notification device 88 performs a takeover request (hereinafter, referred to as TOR) to prompt the vehicle occupant to drive manually. Moreover, the action decision unit 62 measures elapsed time after the TOR is performed, by using a timer 72 provided for the controller 50.

When the vehicle occupant operates the accelerator pedal, operates the braking pedal, or operates or grips the steering wheel in accordance with the TOR, the operation sensors 46 output detection signals that express the operation or the grip. The operation detection unit 64 determines whether the vehicle occupant has taken over the driving operation, on the basis of each detection signal. Until the time of the timer 72 reaches a predetermined time, that is, if the operation detection unit 64 does not detect the detection signal within the predetermined time after the TOR, the action decision unit 62 decides to perform stop control to stop the host vehicle 10. At this time, the action decision unit 62 sets the target speed and the travel trajectory to cause the host vehicle 10 to pull over. The vehicle control unit 66 calculates the deceleration instruction value and the steering instruction value that are necessary to cause the host vehicle 10 to travel at the target speed along the travel trajectory, and outputs the values to the output system device group 80. The driving force output device 82, the steering device 84, and the braking device 86 operate in accordance with the instructions output from the vehicle control unit 66.

Alternatively, if the operation detection unit 64 does not detect the detection signal within the predetermined time after the TOR, the traveling by the automated driving may continue until the vehicle control device 12 cannot continue the automated driving.

### [5.3. Example 3]

If the distance D of the construction section 130 is more than or equal to a predetermined distance Dth, the control state setting unit 60 decides to stop the automated driving temporarily or completely. At this time, the action decision unit 62 decides to perform the TOR for the vehicle occupant. The notification control unit 68 outputs to the notification device 88, the notification instruction in accordance with the notification content that is decided by the action decision unit 62. Then, the notification device 88 performs the TOR to prompt the vehicle occupant to drive manually.

### [5.4. Example 4]

If the function of the steering is automated and the external environment recognition unit 54 recognizes the center line 118 that is a solid line (white or yellow), the action decision unit 62 normally sets the travel trajectory in which the host vehicle 10 does not enter the second travel path 116 from the first travel path 114. However, if the construction section 130 is the one-side alternate traffic as illustrated in FIG. 3, the host vehicle 10 needs to enter the second travel path 116. Thus, the action decision unit 62 temporarily cancels the function of suppressing departure from the first travel path 114, so that the host vehicle 10 can enter the second travel path 116. At this time, the action decision unit 62 decides to perform the notification control to notify the vehicle occupant that the host vehicle 10 will cross the center line 118. The notification control unit 68 outputs to the notification device 88, the notification instruction in accordance with the notification content that is decided by the action decision unit 62. Then, the notification device 88 notifies the vehicle occupant that the host vehicle 10 will cross the center line 118.

### [5.5. Example 5]

If the function of the steering is automated and the external environment recognition unit 54 recognizes the construction vehicle 100c within a predetermined distance from the host vehicle 10, the action decision unit 62 decides to perform offset control that moves the center position of the host vehicle 10 in a vehicle width direction, in a direction opposite from (or away from) the construction vehicle 100c relative to the center position of a travel lane. At this time, the action decision unit 62 sets the offset amount of the host vehicle 10. The vehicle control unit 66 calculates the steering instruction value in accordance with the offset amount, and outputs the value to the output system device group 80. The steering device 84 operates in accordance with the instruction that is output from the vehicle control unit 66.

### [5.6. Example 6]

If the preceding vehicle 100p exists within a predetermined distance from the host vehicle 10, the host vehicle 10 can pass the construction section 130 by performing trajectory trace control to trace a travel trajectory of the preceding vehicle 100p.

### [6. Summary of the Present Embodiment]

The vehicle control device 12 includes: the external environment recognition unit 54 configured to recognize the peripheral state of the host vehicle 10; the control state setting unit 60 configured to set the control state of the automated driving; the action decision unit 62 configured to decide the action of the host vehicle 10 on the basis of the peripheral state that is recognized by the external environment recognition unit 54 and the control state that is set by the control state setting unit 60; and the vehicle control unit 66 configured to perform the travel control of the host vehicle 10 on the basis of the decision result from the action decision unit 62. If the external environment recognition unit 54 recognizes the construction section 130 in the road 110, the control state setting unit 60 is configured to set the control state in accordance with the construction section 130.

In the above configuration, the appropriate automated driving is performed in the construction section 130. In this manner, even when the host vehicle 10 travels in the construction section 130, the function of the automated driving can be continued partially or entirely. Thus, the burden of driving on the vehicle occupant can be reduced.

The control state setting unit 60 is configured to set the control state on the basis of the travel environment information in the construction section 130 that is recognized by the external environment recognition unit 54.

In the above configuration, the automated driving level is set based on the travel environment information. Thus, the automated driving in accordance with the state of the construction section 130 is performed. In this manner, even when the host vehicle 10 travels in the construction section 130, the function of the automated driving can be continued partially or entirely. Thus, the burden of driving on the vehicle occupant can be reduced.

The travel environment information includes at least one piece of information among the entrance information regarding the difficulty of entering the construction section 130, the road surface information regarding the road surface of the construction section 130, the distance information regarding the distance D of the construction section 130, the presence or absence of the map information 42 of the construction section 130, and the weather information regarding the weather in the construction section 130.

The degree of difficulty in the vehicle control changes depending on the difficulty of entering the entrance 130a of the construction section 130, for example, the width W of the entrance 130a. In addition, the degree of difficulty in the vehicle control changes depending on the difference of the road surface of the construction section 130, for example, the asphalt, the iron plate, or the gravel, or a step at the border 124 between the inside and outside of the construction section 130. Moreover, the degree of difficulty in the vehicle control changes depending on the distance D of the construction section 130 involving many uncertainties. Furthermore, the degree of difficulty in the vehicle control changes depending on the presence or absence of the map of the construction section 130. In addition, the degree of difficulty in the vehicle control changes depending on the weather in the construction section 130, for example, the amount of rainfall or the presence or absence of the sunlight.

In the above configuration, the automated driving level is set based on various kinds of information to determine the degree of difficulty in the vehicle control. Thus, the automated driving in accordance with the state of the construction section 130 is performed. In this manner, even when the host vehicle 10 travels in the construction section 130, the function of the automated driving can be continued partially or entirely. Thus, the burden of driving on the vehicle occupant can be reduced.

The vehicle control device 12 further includes the notification control unit 68 configured to perform the notification control to notify the vehicle occupant in accordance with the notification content that is decided by the action decision unit 62. If the distance D of the construction section 130 that is recognized by the external environment recognition unit 54 is more than or equal to the predetermined distance Dth, the action decision unit 62 is configured to decide to perform the notification control to prompt the vehicle occupant to drive manually.

In the above configuration, if the distance D of the construction section 130 involving many uncertainties is long, the vehicle control can be taken over to the vehicle occupant after the TOR or the like is performed. On the other hand, if the distance D of the construction section 130 is short, at least a part of the vehicle control can be continued in the vehicle side.

The vehicle control device 12 further includes the operation detection unit 64 configured to detect the driving operation of the host vehicle 10 by the vehicle occupant. If the operation detection unit 64 does not detect the driving operation within the predetermined time after the notification to prompt the vehicle occupant to drive manually is performed, the action decision unit 62 is configured to decide to perform the stop control to stop the host vehicle 10.

If the vehicle occupant does not drive manually after the notification of the TOR or the like is performed, there is the possibility that the vehicle occupant cannot drive manually. In the above configuration, if the driving operation by the vehicle occupant is not detected after the notification of the TOR or the like is performed, the host vehicle 10 is stopped. Thus, the above configuration can cope with the case where the vehicle occupant cannot drive manually.

If the host vehicle 10 crosses the center line 118 that is the solid line, the action decision unit 62 is configured to decide to perform the notification control to notify that the host vehicle 10 will cross the center line 118 that is the solid line.

In the above configuration, the vehicle occupant is notified that the host vehicle 10 will cross the center line 118 that is the solid line. Thus, even if the vehicle control that is unusual is performed, for example, the host vehicle 10 crosses the center line 118 that is the solid line, the vehicle occupant can understand that this vehicle is normally controlled.

If the host vehicle 10 travels in the construction section 130, the action decision unit 62 is configured to decide to perform the notification control to notify that the host vehicle 10 will travel in the construction section 130.

In the above configuration, the vehicle occupant is notified that the host vehicle 10 travels in the construction section 130. Thus, even if the vehicle control that is unusual is performed, the vehicle occupant can understand that this vehicle control is performed in order to travel in the construction section 130. If the external environment recognition unit 54 recognizes the construction vehicle 100c within the predetermined distance from the host vehicle 10, the action decision unit 62 is configured to decide to perform the offset control that moves the center position of the host vehicle 10 in the vehicle width direction, in the direction that is opposite from the position of the construction vehicle 100c relative to the center position of the travel lane.

There is a case where the construction vehicle 100c in the construction section 130 moves suddenly and a part of the construction vehicle 100c enters the travel path of the host vehicle 10. In the above configuration, the position of the host vehicle 10 is moved in the direction that is opposite from the construction vehicle 100c. Thus, even if a part of the construction vehicle 100c enters the travel path of the host vehicle 10, the host vehicle 10 is prevented from being in contact with the construction vehicle 100c.

If the external environment recognition unit 54 recognizes the preceding vehicle 100p that travels ahead of the host vehicle 10, the action decision unit 62 is configured to decide to perform the trajectory trace control that causes the host vehicle 10 to travel along the travel trajectory of the preceding vehicle 100p.

In the above configuration, the host vehicle 10 travels along the travel trajectory of the preceding vehicle 100p. Thus, the host vehicle 10 can travel in the construction section 130 relatively easily.

The vehicle control device according to the present invention is not limited to the embodiment above, and can employ various configurations without departing from the gist of the present invention.

What is claimed is:

1. A vehicle control device comprising:
an external environment recognition unit configured to recognize a peripheral state of a host vehicle;
a control state setting unit configured to set a control state of automated driving;
an action decision unit configured to decide an action of the host vehicle on a basis of the peripheral state that is recognized by the external environment recognition unit and the control state that is set by the control state setting unit; and
a vehicle control unit configured to perform travel control of the host vehicle on a basis of a decision result from the action decision unit,
wherein if the external environment recognition unit recognizes a construction section in a road, the control state setting unit is configured to set the control state in accordance with the construction section.

2. The vehicle control device according to claim 1, wherein the control state setting unit is configured to set the control state on a basis of travel environment information in the construction section that is recognized by the external environment recognition unit.

3. The vehicle control device according to claim 2, wherein the travel environment information includes at least one piece of information among entrance information regarding difficulty of entering the construction section, road surface information regarding a road surface of the construction section, distance information regarding a distance of the construction section, presence or absence of map information of the construction section, and weather information regarding weather in the construction section.

4. The vehicle control device according to claim 1, further comprising a notification control unit configured to perform notification control to notify a vehicle occupant in accordance with notification content that is decided by the action decision unit,
wherein if a distance of the construction section that is recognized by the external environment recognition unit is more than or equal to a predetermined distance, the action decision unit is configured to decide to perform the notification control to prompt the vehicle occupant to drive manually.

5. The vehicle control device according to claim 4, further comprising an operation detection unit configured to detect a driving operation of the host vehicle by the vehicle occupant,
wherein if the operation detection unit does not detect the driving operation within a predetermined time after the notification to prompt the vehicle occupant to drive manually is performed, the action decision unit is configured to decide to perform stop control to stop the host vehicle.

6. The vehicle control device according to claim 1, further comprising a notification control unit configured to perform notification control to notify a vehicle occupant in accordance with notification content that is decided by the action decision unit,
wherein if the host vehicle crosses a center line that is a solid line, the action decision unit is configured to decide to perform the notification control to notify that the host vehicle will cross the center line that is the solid line.

7. The vehicle control device according to claim 1, further comprising a notification control unit configured to perform notification control to notify a vehicle occupant in accordance with notification content that is decided by the action decision unit,
wherein if the host vehicle travels in the construction section, the action decision unit is configured to decide to perform the notification control to notify that the host vehicle will travel in the construction section.

8. The vehicle control device according to claim 1, wherein if the external environment recognition unit recognizes a construction vehicle within a predetermined distance from the host vehicle, the action decision unit is configured to decide to perform offset control that moves a center position of the host vehicle in a vehicle width direction, in a direction that is opposite from a position of the construction vehicle relative to a center position of a travel lane.

9. The vehicle control device according to claim 1, wherein if the external environment recognition unit recognizes a preceding vehicle that travels ahead of the host vehicle, the action decision unit is configured to decide to perform trajectory trace control that causes the host vehicle to travel along a travel trajectory of the preceding vehicle.
